(19) United States
(12) Patent Application Publication
(10) Pub. No.: US 2006/0202907 A1
(43) Pub. Date: Sep. 14, 2006

(54) ANTENNA

(75) Inventors: Ovadia Grossman, Tel Aviv (IL); Moshe Bem-Ayun, Shoham (IL); Mark Rozental, Rehovot (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/421,378

(22) Filed: May 31, 2006

(30) Foreign Application Priority Data
Dec. 13, 2003 (GB) GB0328922.0
Sep. 30, 2004 (WO) PCT/GB04/52387

(51) Int. Cl. H01Q 1/36

(52) U.S. Cl. 343/895

(57) ABSTRACT

An antenna for use in a mobile radio communication device includes a conductive helical or spiral coil portion extending along an axis and, galvanically coupled to the coil portion, a conductive capacitive top load portion, wherein the coil portion and the top load portion are mutually arranged to provide an electrically resonant structure in a frequency band of operation of the device, wherein the coil portion has a first part and a second part and at least part of the top load portion extends outside or alongside the second part but not the first part of the coil portion, wherein the resonant structure has a plurality of electrical resonances at frequencies in a frequency band of operation of the device, and the first and second parts of the coil portion contribute to one of the resonances and the first part of the coil portion and the second portion contribute to another of the resonances.

### FIELD OF THE INVENTION

The present invention relates to an antenna. The antenna is for use in radio communications particularly for use in a mobile radio communications unit.

### BACKGROUND OF THE INVENTION

Mobile communications are carried out using mobile radio communications units known in the art as ‘mobile stations’ which include a transmitter to convert messages or information of a user input mainly in the form of speech, but possibly also in the form of text data and/or visual images etc., into radio frequency (RF) signals for transmission to a distant receiver, and a receiver to convert received RF signals from a distant transmitter back into information which can be understood by the user. Many components of the transmitter and receiver are common components usually forming a single transceiver unit.

In a mobile station, the function of sending and receiving an RF signal via an air interface to and from a distant transceiver is carried out by a component referred to in the art as an antenna or aerial. In general, an antenna is a device which converts an electrical signal oscillating at RF frequency into a radiated electromagnetic energy signal and vice versa.

In modern mobile communications, such as using digital technology, the RF signals generally have a high frequency, e.g. above 30 MHz. For example, for systems operating according to TETRA standard procedures, an operating frequency is in a specified range in the region of 400 MHz, e.g. from 410 MHz to 430 MHz, centre frequency 420 MHz. TETRA (Terrestrial Trunked Radio) is a set of operational industry standard procedures defined by the European Telecommunications Standards Institute (ETSI). The frequency of such systems is often referred to as ‘UHF’ (ultra high frequency).

Generally, antennas for use in TETRA and other UHF mobile stations are limited in frequency bandwidth. Usually, the higher the frequency of operation, i.e. the smaller the antenna, the narrower (on a percentage basis) is the bandwidth of the antenna. For operation in multiple frequency bands multiple resonators are normally used and each has a bandwidth of not more than about 10% (of the operating centre frequency). However, for new wireless communication services which are currently emerging, the bandwidth required is greater than the conventional 10%. For example, there are different TETRA systems in various different geographical regions designed to operate at 380-470 MHz as well as at 410-430 MHz and some are planned for 450-470 MHz. A roaming service will enable a mobile station to be handed over seamlessly between such different systems, when moving from one geographical region to another.

The purpose of the present invention is to provide a novel antenna of a form which can be designed to provide a bandwidth greater than that of known antennas for use in mobile communications.

Antenna configurations for many different applications are described in the prior art. GB-A-2282487 and U.S. Pat. No. 5,216,436 are mentioned as giving examples of prior art configurations. These configurations include a ‘top hat’ portion which is required to occupy a considerable volume.

In addition, GB-B-2380323 describes an antenna (for use in a radio communication device), having a length of not greater than 100 mm and including a first portion comprising a conductive helical or spiral coil extending along an axis and electrically connected to a further portion, namely a conductive capacitive portion comprising a hollow cylinder extending along the axis of the coil. The present invention is intended to give an improved bandwidth performance compared with that obtainable with the antenna of GB-B-2380323.

### SUMMARY OF THE PRESENT INVENTION

According to the present invention in a first aspect there is provided an antenna for use in a radio communication device including a first portion which is a conductive helical or spiral coil portion extending along an axis and, electrically coupled to the first portion, a second portion which is a conductive capacitive top load portion, wherein the first portion and the second portion are mutually arranged to provide an electrically resonant structure, wherein the first portion has a first part and a second part and at least part of the second portion extends outside or alongside the second part but not the first part of the first portion, wherein the resonant structure has a plurality of electrical resonances at frequencies in a frequency band of operation of the device, and the first and second parts of the first portion contribute to one of the resonances and the first part of the first portion and the second portion contribute to another of the resonances.

The second portion may comprise at least one conductive member extending outside the second part of the first portion, e.g. extending along or parallel to said axis, or extending at an acute angle to said axis. The at least one conductive member may comprise for example a conductive plate or strip or a hollow cylindrical member each extending along, parallel to or at an angle to said axis.

Where each conductive member comprises a strip, preferably the second portion includes two or more strips, preferably from two to four such strips.

Where the conductive member comprises a hollow cylindrical member it may optionally include one or more slots or holes, e.g. extending lengthwise along the cylindrical portion.

The first portion and the second portion may have a common axis. The first portion may comprise a single coil or multiple coils. In any case, the coil portion is divided into the first and second parts by the coupling to the second portion.

It is possible for the electrical coupling between the first coil portion and the second top load portion (including its mutiple conductive members, e.g. strips where used) to be other than galvanic, e.g. a capacitive coupling provided by a dielectric coupling ring. However, the coupling is preferably a galvanic coupling, e.g. by use of a suitable conductive coupling ring.

In one form of the antenna according to the invention, the second portion may be adjustable in position relative to the first coil portion whereby the frequency response (e.g. as measured by antenna return loss versus frequency) of the resonant structure is adjustable. The relative position may be subsequently fixed after it has been optimised, e.g. by measuring frequency response for various adjusted relative positions.

In a preferred form of the antenna according to the invention, the second portion may have a variable distance of separation from the second part of the coil portion. The distance of separation may increase with distance from the coupling between the coil portion and the second portion. In this case, the second portion may for example comprise a plurality of strips extending outward at an angle to the axis of the coil portion or a slotted frusto-conical shaped portion.

The antenna according to the invention may include a further portion for connection to a conductor of the radio device. The further portion may for example comprise an elongate portion, for example a conductive linear stub portion or a coaxial cable portion. The elongate may have an axis which substantially co-incides with or is parallel to the axis of the coil portion.

In another preferred form of the antenna according to the invention, the coil of the first portion may have a varying helical or spiral pitch. The coil portion may include for example at least a first section having a first helical pitch and a second section having a second helical pitch. The first and second sections may be the same as the first and second parts of the coil portion referred to earlier. Alternatively, the second section may start at a different location on the coil from the second part of the coil, i.e. the part inside the second top load portion. For example, the second section may start in a position which is in the first part of the coil portion outside the second top load portion. Alternatively, the pitch may vary continuously in at least a part of the first coil portion. In any case, the pitch may be longer at an end thereof nearer a conductor of the radio device and shorter where further from the conductor of the radio device.

Beneficially and surprisingly, a very wideband and satisfactory performance is provided by the antenna according to the invention yet the overall shape and size, or form factor, of the antenna does not have to be significantly greater than that of known single frequency antenna for use in a mobile station. The antenna is therefore suitable for use in a mobile station for use in radio communications, particularly where wideband performance is needed, e.g. to provide operation at two different frequencies in a given range. An antenna embodying the invention may for example provide a bandwidth which encompasses resonance components at 380 MHz and 430 MHz, thereby providing a compact and suitably efficient structure for operation in multiple TETRA frequency ranges.

According to the present invention in a second aspect there is provided a mobile station for use in radio communications which includes the novel antenna according to the first aspect of the invention.

Embodiments of the present invention will now be described by way of example with reference to the accompanying drawings, in which:

### BRIEF DESCRIPTION OF THE ACCOMPANYING DRAWINGS

FIG. 1 is a side cross-sectional view of an antenna embodying the invention.

FIG. 2 is a side cross-sectional view of an alternative antenna embodying the invention.

FIG. 3 is a graph of return loss versus frequency obtained in practice for an antenna of the form shown in FIG. 1.

FIG. 4 is a diagrammatic illustration of a further antenna embodying the invention.

FIG. 5 is a diagrammatic illustration of a further antenna embodying the invention.

FIG. 6 is a diagrammatic illustration of a further antenna embodying the invention.

### DESCRIPTION OF EMBODIMENTS OF THE INVENTION

As shown in FIG. 1, an antenna 100 embodying the invention for use in a mobile station (not shown) has a longitudinally extending axis 102 and comprises a first conducting coil portion 103, a second conducting portion 105 and a third conducting portion 107. The antenna 100 is connected at its inner end (the left hand end as shown) to a RF signal conductor 104 connected to a RF transceiver of the mobile station (not shown). The first, second and third portions may be made of a copper based material or other efficiently conducting material well known and used in the art. The antenna 100 is enclosed in a conventional manner in an insulating case, e.g. made of a moulded plastics material. The case is not shown in FIG. 1 but its outer envelope is indicated by a dashed line 109. The case is conventional and provides mechanical and environmental protection of the antenna 100. The case has a conducting end plate 110 between the third portion 107 and the first portion 103.

The second portion 105 comprises a curved plate 106 forming a hollow cylindrical shape extending along the axis 2. It is connected to the first portion 3 by a conducting coupling ring 111 at the inner end of the second portion 105. The curved plate 106 forms in cross section in a plane perpendicular to the axis 102 an extended arc of greater than 270 degrees, e.g. greater than 300 degrees. The curved plate 106 has longitudinally extending edges 113 and 115 facing one another and a gap 117 extending between the edges 113 and 115. The second portion 105 functions as a capacitive top load portion.

The first portion 103 comprises a helical coil extending along the axis 102 of the antenna 100. The coupling ring 111 divides the coil of the first portion 103 into a first part 119 nearer the third portion 107 and a second part 121 further from the third portion 107. The second part 121 extends along the axis 102 inside the curved plate 106 of the second portion 105, although an outer end of the portion 105 extends beyond an outer end of the second part 121.

In operation, the antenna 100 exhibits (at least) two RF electrical resonances. A first resonance is produced by the combined structure of the third portion 107, the first part 119 of the first portion 103 and the second portion 105. A second resonance is produced by the combined structure of the third portion 107, the first part 119 of the first portion 103 and the second part 121 of the first portion 103. The individual resonance frequencies can be measured separately, although in practice it is possible to plot an overall frequency response curve in which both resonances may be observed. If the second portion 105 is adjustable in lengthwise position, it is possible by moving the second portion 105 (i.e. by moving the position of the coupling ring 111) to determine which one of the two resonances is due to the structure including the second portion 105. Thus, the antenna 100 is a superposition or composite of two antennas, one including the second portion 105 and the other including the second part 121 of the fist portion 103, the other components of the two antennas being common.

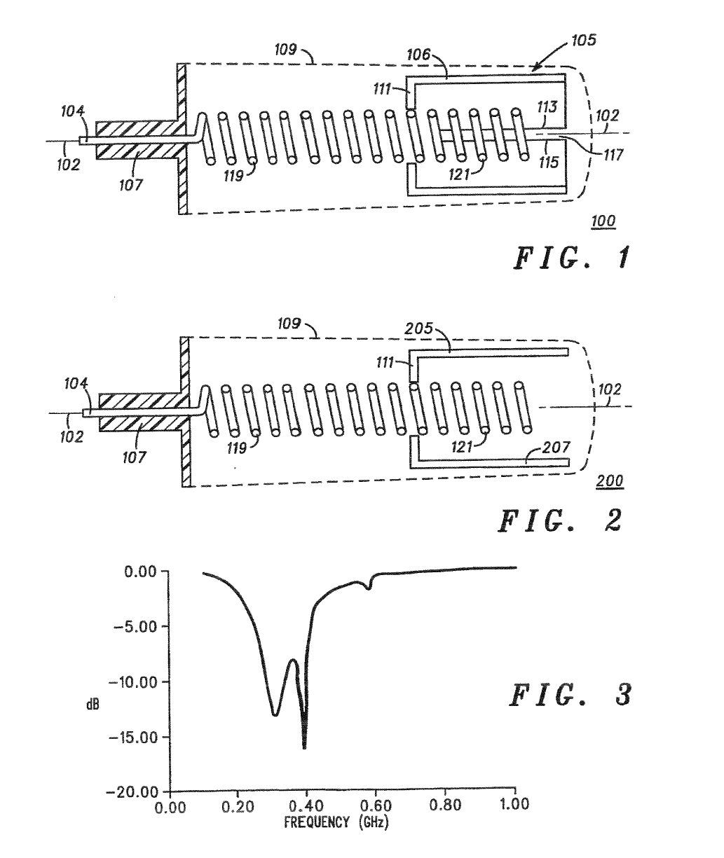

FIG. 2 shows an alternative antenna 200 embodying the invention. Components of the antenna 200 which are the same as those of the antenna 100 of FIG. 1 are indicated by the same reference numerals. In the antenna 200, the curved plate 106 of the second portion 105 is replaced by a first conducting strip 205 and a second conducting strip 207 extending from the coupling ring 111. The strips 205 and 207 may be arranged to face one another. However, this is not essential. The strips 205 and 207 could be at various other angles relative to one another. Also, there could be more than two lengthwise extending strips connected to the coupling ring 111 included in the second portion 105 of the antenna 200.

The shape and the proximity of the second portion 105 to the second part 121 of the first portion 103 of the antenna 100 is important in determining the overall frequency response of the antenna 100. The proper optimization of the load is easy to estimate empirically: the greater the top loading length the better, and a better resonance Q factor will be achieved. (Q factor is a measure of inverse of resonance width: a low Q factor, e.g. 4 indicates a wide resonance curve). However, in practice the optimisation is not so simple. The overall length of the antenna which is usually limited by space and size design constraints within the mobile station is limited. Nevertheless, for an antenna having an overall length of about 5 cm (a typical acceptable upper limit of overall antenna length), a top load of the form illustrated in FIG. 2 having a length of about 2.5 cm and comprising two or three conducting strips 2 mm wide provides a suitable compromise.

In practice, two location points on the frequency response curve can be found which give optimum Q factor, i.e. maximum local bandwidth, such that deviation from the selected location point reduces the bandwidth. These points can be found experimentally by adjusting the second portion (i.e. by adjusting the coupling ring 111) in position lengthwise relative to the first portion 103. These two location points are related to the impedance of the antenna 100. One shows a simple wide resonance and is found at a frequency lower than the main coil resonance frequency, and the other with distinct dual resonance features (due to conjugate impedance coupling) and a wider resonance bandwidth is found at a higher frequency. Both optimum points can be used in practice.

FIG. 3 is an illustration of the resonance curve obtained using the higher frequency optimum point. FIG. 3 is a graph of return loss (−dB) versus frequency (GHz) for an example of an antenna of the form shown in FIG. 2. (Return loss is a measure of power reflected into the antenna or antenna efficiency. Minimum return loss is equivalent to maximum outward transmission power). The antenna giving the curve shown in FIG. 3 had a length of 4 cm and an outer diameter of 7 mm. As seen in FIG. 3, a dual resonance is obtained in the region 0.3 GHz-0.4 GHz in a resonance structure having a bandwidth of 0.15 GHz at −6 dB return loss.

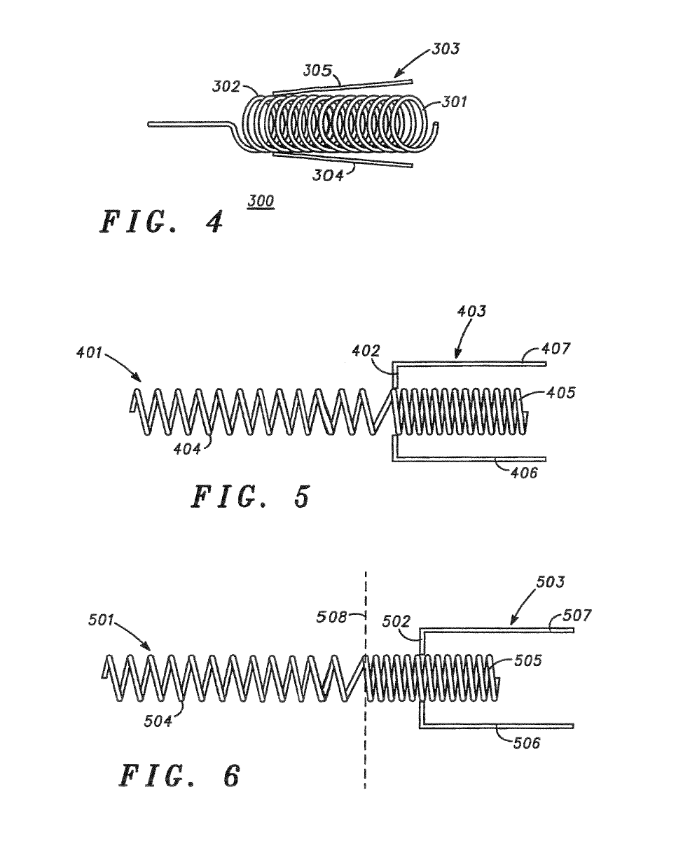

The dual frequency antenna model which has been described can provide a bandwidth which is typically two to three times that of a standard coil antenna which typically has a bandwidth of about 20-25 MHz at 400 MHz. Furthermore the bandwidth obtained can be substantially greater than, e.g. up to 40-50 MHz greater than, the bandwidth of an antenna of comparable dimensions of the form described in GB-B-2380323. However, even better results are possible with antennas embodying the invention if the loading provided by the capacitive top load portion and/or the distance of separation between the capacitive top load portion and the part of the coil portion inside it is varied along the length of the top load portion. This is because the effect can be to provide a more beneficial distributed loading rather than a locally concentrated loading. An example including such a variation is shown diagrammatically in FIG. 4. In this case, another antenna 300 embodying the invention comprises (optionally in addition to a connecting portion such as a linear stub third portion—not shown) a first portion 301 which is a conducting helical coil and, galvanically coupled to the helical coil at a coupling position 302, a second portion 303 which comprises a first conducting strip 304 and a second conducting strip 305. The strips 304 and 305 slope away from the axis of the coil. The distance between each of the strips 304 and 305 and the coil of the portion 301 therefore increases gradually toward the outer end (the right hand end as seen in FIG. 4). The benefit of the antenna form shown in FIG. 4 is that an extra feature is provided to control impedance interaction between the respective resonances leading to the possibility of an even greater overall bandwidth.

In a further embodiment illustrated diagrammatically in FIG. 5, an antenna 400 comprises (optionally in addition to a connecting portion—not shown) a first portion 401 which comprises a conducting helical coil and a second portion 403, coupled to the helical coil 401 at a position 402, which comprises a first strip 406 and a second strip 407. The coil of the first portion 401 has two selected pitch sections 404 and 405 respectively. In the first section 404 the coil has a long pitch. In the second section 405 which begins at the position 402, the coil has a short pitch. The first section 404 and the second section 405 co-incide respectively with the first and second parts of the coil portion referred to earlier.

In a further embodiment illustrated diagrammatically in FIG. 5, an antenna 500 comprises (optionally in addition to a connecting portion—not shown) a first portion 501 which comprises a conducting helical coil and a second portion 503 which comprises a first strip 506 and a second strip 507 connected to the coil at a coupling position 502. The coil of the first portion 501 has two selected pitch sections 504 and 505 respectively. The junction between the sections 504 and 505 is indicated by a dashed line 508. In the first section 504, the coil has a long pitch. In the second section 505, the coil has a short pitch. The second section 505 at junction 508 begins prior to the position 502 at which the second top load portion 503 begins. In other words, in the first part of the coil portion 501 outside the second portion 503 the coil has (i) at its inner end a long pitch up to junction 508; and (ii) extending beyond the junction 508 a short pitch; the short pitch continues when the coil is inside the second portion 503. The dual pitch arrangement gives an improvement in radiation properties of the antenna and the efficiency of the antenna, by reducing conductor losses in the conducting wire of the coil.

In a practical example of the antenna 400 and the antenna 500, the coil had an outside diameter of 6.5 mm, the long pitch section of the coil had a length of 20 mm and a pitch of 4 mm and the short pitch section of the coil had a length of 14.4 mm and a pitch of 1.2 mm. Such an antenna gave suitable operational performance across the range 370-450 MHz, e.g. it was suitable for use in multiple TETRA systems.

1. An antenna for use in a radio communication device including: a first portion which is a conductive helical or spiral coil portion extending along an axis and, electrically coupled to the first portion, a second portion which is a conductive capacitive top load portion, wherein the first portion and the second portion are mutually arranged to provide an electrically resonant structure, wherein the first portion has a first part and a second part and at least part of the second portion extends outside or alongside the second part but not the first part of the first portion, wherein the resonant structure has a plurality of electrical resonances at frequencies in a frequency band of operation of the device, and the first and second parts of the first portion contribute to one of the resonances and the first part of the first portion and the second portion contribute to another of the resonances, wherein there is an electrical coupling between the coil of the first portion and the second portion which is a galvanic coupling.

2. An antenna according to claim 1 wherein the second portion comprises at least one conductive member.

3. An antenna according to claim 2 wherein the second portion extends outside at least a region of the second part of the first portion.

4. An antenna according to claim 3 wherein at least one conductive member extends along or parallel to said axis or at an acute angle to said axis.

5. An antenna according to claim 4 wherein the conductive member comprises at least one conductive plate or strip.

6. An antenna according to claim 5 wherein the second portion includes from two to four conductive strips.

7. An antenna according to claim 1 wherein the second portion comprises: a curved plate, hollow cylindrical, or a conical portion.

8. An antenna according to claim 7 wherein the second portion includes a hollow cylindrical or conical member including one or more slots or holes.

9. An antenna according to claim 8 wherein the second portion includes a hollow cylindrical member and one or more slots or holes extend lengthwise along the cylindrical member.

10. An antenna according to claim 9 wherein the coil of the first portion and the second portion have a common axis.

11. An antenna according to claim 10 wherein the second portion is at least temporarily adjustable in postion relative to the first portion whereby the frequency response of the antenna is adjustable.

12. An antenna according to claim 11 wherein the second portion has a variable distance of separation from the second part of the first portion.

13. An antenna according to claim 12 wherein the distance of separation increases with distance from a position of coupling between the first portion and the second portion.

14. An antenna according to claim 13, wherein the second portion comprises a plurality of strips extending outward at an angle to the axis of the coil portion or a slotted frusto-conical shaped portion.

15. An antenna according to claim 14 which includes a further portion for connection to a conductor of the radio device.

16. An antenna according to claim 15 wherein the further portion comprises an elongate conductive linear stub portion or a coaxial cable portion.

17. An antenna according to claim 15 wherein the further portion has an axis which substantially co-incides with or is parallel to the axis of the coil of the first portion.

18. An antenna according to claim 17 wherein the coil of the first portion has a varying helical or spiral pitch.

19. An antenna according to claim 18 wherein the coil of the first portion includes a first section having a first helical pitch and a second section having a second helical pitch.

20. An antenna according to claim 19 wherein the first and second regions may be the same as the first and second sections of the coil of the first portion are the same as said first and second parts.
